(19) United States
(12) Patent Application Publication
(10) Pub. No.: US 2026/0079314 A1
(43) Pub. Date: Mar. 19, 2026

(54) ELECTRONIC PACKAGE AND MANUFACTURING METHOD THEREOF

(71) Applicant: SILICONWARE PRECISION INDUSTRIES CO., LTD., Taichung City (TW)

(72) Inventors: Feng KAO, Taichung City (TW); Wen-Jung TSAI, Taichung City (TW); Siang-Yu LIN, Taichung City (TW)

(73) Assignee: SILICONWARE PRECISION INDUSTRIES CO., LTD., Taichung City (TW)

(21) Appl. No.: 19/049,712

(22) Filed: Feb. 10, 2025

(30) Foreign Application Priority Data
Sep. 13, 2024 (TW) 113134926

(51) Int. Cl. G02B 6/42; G02B 6/43

(52) U.S. Cl. CPC G02B 6/4268; G02B 6/43

(57) ABSTRACT

An electronic package and a manufacturing method thereof are provided. The electronic package includes an electronic element, a photonic element, a first circuit structure, a second circuit structure and a heat-conducting layer. The electronic element has an active surface and a non-active surface opposite to the active surface. The first circuit structure is disposed between the electronic element and the photonic element and is electrically connected to the electronic element and the photonic element. The second circuit structure is electrically connected to the first circuit structure. The heat-conducting layer is formed between the non-active surface of the electronic element and the second circuit structure, and the second circuit structure is thermally coupled to the electronic element via the heat-conducting layer, thereby to improve heat dissipation efficiency of the electronic element during operation.

### BACKGROUND

### 1. Technical Field

The present disclosure relates to a package structure, and more particularly, to an electronic package and a manufacturing method thereof.

### 2. Description of Related Art

FIG. 1 is a schematic cross-sectional view showing a conventional semiconductor package 1. The semiconductor package 1 includes a first redistribution layer 11, a semiconductor chip 13, a plurality of conductive pillars 12, an encapsulation colloid 14, a second redistribution layer 15, a plurality of conductive elements 16 and a photonic chip 17.

The first redistribution layer 11 includes an insulating layer 111 and a circuit layer 112 combining with the insulating layer 111. The semiconductor chip 13 is bonded to the lower side of the first redistribution layer 11 and the circuit layer 112 via its active surface on the upper side of the semiconductor chip 13 and first conductive bumps 131, and the photonic chip 17 is bonded to the upper side of the first redistribution layer 11 and the circuit layer 112 via its functional surface on the lower side of the photonic chip 17 and second conductive bumps 171. The first conductive bumps 131 are covered by a first underfill 132, and the second conductive bumps 171 are covered by a second underfill 172.

The semiconductor chip 13 is bonded to the upper side of the second redistribution layer 15 via an adhesive layer 133. The second redistribution layer 15 includes an insulating layer 151 and a circuit layer 152 combining with the insulating layer 151. The conductive pillars 12 are disposed between the first redistribution layer 11 and the second redistribution layer 15 and are electrically connected to the circuit layer 112 of the first redistribution layer 11 and the circuit layer 152 of the second redistribution layer 15. The encapsulation colloid 14 is formed between the first redistribution layer 11 and the second redistribution layer 15 and covers the semiconductor chip 13, the adhesive layer 133 and the conductive pillars 12. The conductive elements 16 are disposed on the lower side of the second redistribution layer 15 and are electrically connected to the circuit layer 152 of the second redistribution layer 15.

Advanced semiconductor manufacturing processes such as 7 nanometers, 5 nanometers, or smaller dimension need to go with more efficient chip heat dissipation technology. However, the semiconductor chip 13 as shown in FIG. 1 is surrounded by the first underfill 132, the encapsulation colloid 14 and the adhesive layer 133, which causes the poor heat dissipation. Therefore, how to provide a package structure that is conducive to heat dissipation to prevent the semiconductor chip 13 from overheating has become an urgent technical issue that needs to be solved.

### SUMMARY

In view of the aforementioned shortcomings of the prior art, the present disclosure provides an electronic package, which comprises: an electronic element, a photonic element, a first circuit structure, a second circuit structure and a heat-conducting layer. The electronic element has an active surface and a non-active surface opposite to the active surface. The first circuit structure is disposed between the electronic element and the photonic element and is electrically connected to the electronic element and the photonic element. The heat-conducting layer is formed between the non-active surface of the electronic element and the second circuit structure to improve heat dissipation efficiency of the electronic element during operation. The second circuit structure is electrically connected to the first circuit structure and is thermally coupled to the electronic element via the heat-conducting layer.

The present disclosure further provides a method of manufacturing an electronic package, the method comprises: disposing an electronic element on a first circuit structure, wherein the electronic element has an active surface and a non-active surface opposite to the active surface; forming a heat-conducting layer on the non-active surface of the electronic element to improve heat dissipation efficiency of the electronic element during operation; forming a second circuit structure on the heat-conducting layer, wherein the second circuit structure is electrically connected to the first circuit structure and is thermally coupled to the electronic element via the heat-conducting layer; and disposing a photonic element on the first circuit structure, wherein the photonic element is electrically connected to the electronic element via the first circuit structure.

In the electronic package and manufacturing method thereof of the present disclosure, the heat-conducting layer is attached to the non-active surface of the electronic element, and the second circuit structure is thermally coupled to the electronic element via the heat-conducting layer to improve the heat dissipation efficiency of the electronic element during operation.

### BRIEF DESCRIPTION OF THE DRAWINGS

FIG. 1 is a schematic cross-sectional view showing a conventional semiconductor package.

FIG. 2 to FIG. 5 are schematic cross-sectional views showing a manufacturing method of an electronic package according to an embodiment of the present disclosure.

FIG. 6 is a schematic cross-sectional view showing an electronic package according to another embodiment of the present disclosure.

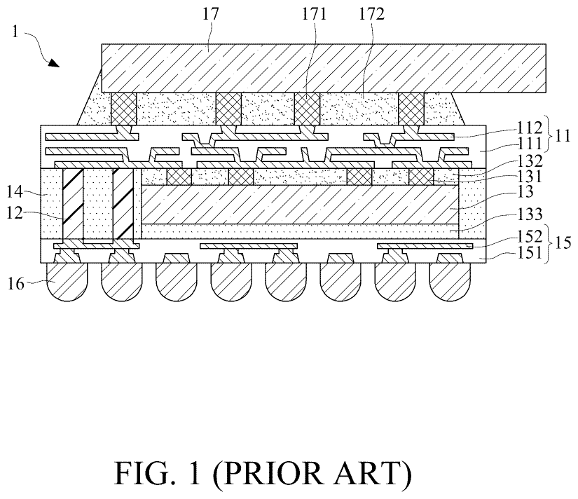

### DETAILED DESCRIPTION

Implementations of the present disclosure are described below by embodiments. Other advantages and technical effects of the present disclosure can be readily understood by one of ordinary skill in the art upon reading the disclosure of this specification.

It should be noted that the structures, ratios, sizes shown in the drawings appended to this specification are provided in conjunction with the disclosure of this specification in order to facilitate understanding by those skilled in the art. They are not meant, in any ways, to limit the implementations of the present disclosure, and therefore have no substantial technical meaning. Without influencing the effects created and objectives achieved by the present disclosure, any modifications, changes or adjustments to the structures, ratios, or sizes are construed as falling within the scope covered by the technical contents disclosed herein. Meanwhile, terms such as “on,” “upper,” “under,” “lower,” “a,” “one,” “first,” “second,” and the like are for illustrative purposes, and are not meant to limit the scope implementable by the present disclosure. Any changes or adjustments made to the relative relationships, without substantially modifying the technical contents, are also to be construed as within the scope implementable by the present disclosure.

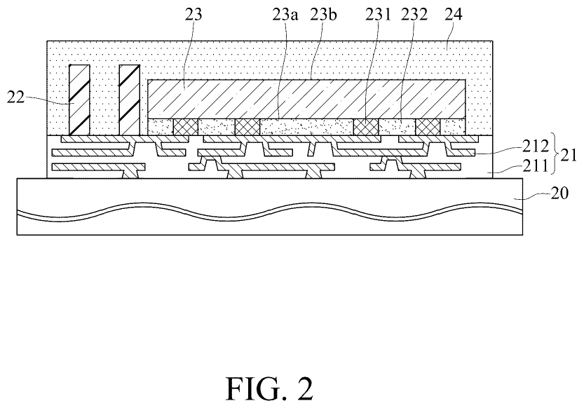

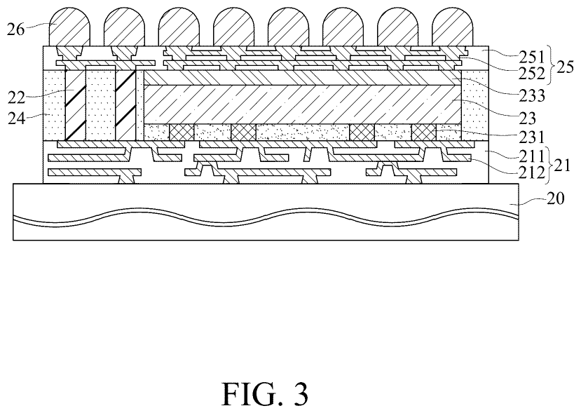

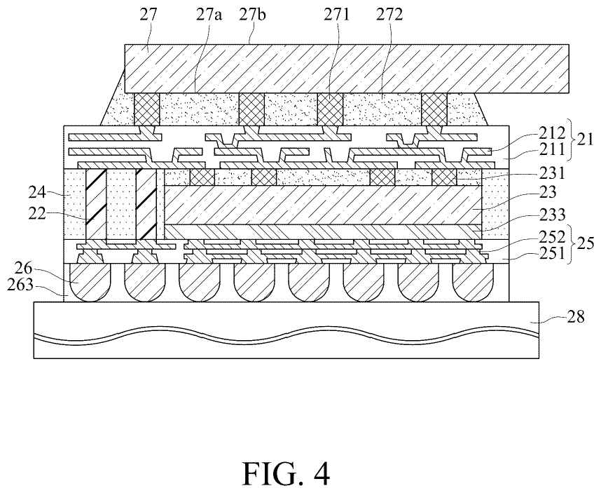

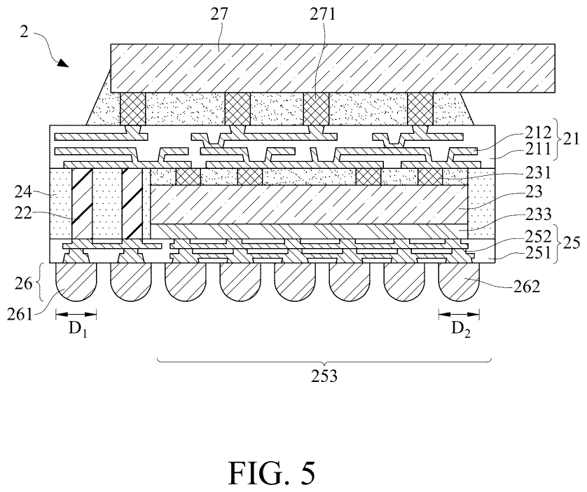

FIG. 2 to FIG. 5 are schematic cross-sectional views showing a manufacturing method of an electronic package 2 according to an embodiment of the present disclosure. Each element shown in FIG. 2 to FIG. 5 has a first side and a second side opposite to the first side, the first side is the lower side shown in FIG. 2 and FIG. 3 and the upper side shown in FIG. 4 and FIG. 5, and the second side is the upper side shown in FIG. 2 and FIG. 3 and the lower side shown in FIG. 4 and FIG. 5.

First, as shown in FIG. 2, a first circuit structure 21 is formed on a first carrier 20, and conductive pillars 22 and an electronic element 23 are disposed on the second side of the first circuit structure 21.

The first circuit structure 21 includes at least one insulating layer 211 and at least one circuit layer 212 combining with the insulating layer 211. For example, the material forming the circuit layer 212 can be copper or other conductive materials, and the material forming the insulating layer 211 can be polybenzoxazole (PBO), polyimide (PI), prepreg (PP), or other dielectric materials.

The material forming the conductive pillars 22 can be copper or other metals, or other conductive materials.

The electronic element 23 can be an active element, a passive element, or a combination of the active element and the passive element. The active element is, for example, a semiconductor chip, and the passive element is, for example, a resistor, a capacitor, or an inductor. The first side of the electronic element 23 is an active surface 23a, and the second side of the electronic element 23 is a non-active surface 23b. The electronic element 23 is coupled to the second side of the first circuit structure 21 via its active surface 23a and a plurality of first conductive blocks 231 in a flip-chip manner. The first conductive blocks 231 may be formed of solder material or conductive metal material. The first conductive blocks 231 are covered with a first underfill 232.

Moreover, an encapsulation layer 24 is formed on the second side of the first circuit structure 21 and covers the electronic element 23 and the conductive pillars 22. The material forming the encapsulation layer 24 is insulating material, for example, polyimide (PI), epoxy molding colloid, or epoxy molding compound. The encapsulation layer 24 may be formed by molding, lamination, or coating.

As shown in FIG. 3, part of the encapsulation layer 24 is removed to expose one end (i.e., the upper end shown in FIG. 3) of each of the conductive pillars 22 and the non-active surface 23b of the electronic element 23. Next, a heat-conducting layer 233 is formed on the non-active surface 23b of the electronic element 23, and a second circuit structure 25 is formed on the heat-conducting layer 233 and the encapsulation layer 24, such that the second circuit structure 25 is electrically connected to the first circuit structure 21 via the conductive pillars 22 and is thermally coupled to the electronic element 23 via the heat-conducting layer 233. When it is necessary to remove part of the encapsulation layer 24 to expose one end of each of the conductive pillars 22 and the non-active surface 23b of the electronic element 23, the part of the encapsulation layer 24 may be removed by grinding.

The heat-conducting layer 233 may be made of metal material with high thermal conductivity, such as copper, to transfer the heat generated from the electronic element 23 during operation to the second circuit structure 25, so as to improve the heat dissipation efficiency of the electronic element 23 during operation.

The second circuit structure 25 includes at least one insulating layer 251 and at least one circuit layer 252 combining with the insulating layer 251. For example, the material forming the circuit layer 252 may be copper or other conductive materials, and the material forming the insulating layer 251 may be the aforementioned polybenzoxazole (PBO), polyimide (PI), prepreg (PP), or other dielectric materials.

In addition, a plurality of conduction elements 26 are disposed on the second side of the second circuit structure 25. Each of the conduction elements 26 is, for example, a conductive pillar or a conductive bump.

As shown in FIG. 4, the first carrier 20 is removed, the semi-finished electronic package product shown in FIG. 3 is turned upside down, and the semi-finished product is placed on a second carrier 28 via the conduction elements 26 and an adhesive glue 263. Then, a photonic element 27 is disposed on the first circuit structure 21, such that the photonic element 27 is electrically connected to the electronic element 23 via the first circuit structure 21.

The photonic element 27 may be a semiconductor element with the function of emitting and/or receiving optical signals.

The first side of the photonic element 27 is a non-functional surface 27b, and the second side of the photonic element 27 is a functional surface 27a. The photonic element 27 is coupled to the first side of the first circuit structure 21 via its functional surface 27a and a plurality of second conductive blocks 271 in a flip-chip manner. The second conductive blocks 271 may be formed of solder material or conductive metal material. Additionally, the second conductive blocks 271 are covered by a second underfill 272.

The first circuit structure 21 has a first side and a second side opposite to the first side, the photonic element 27 is disposed on the first side of the first circuit structure 21, and the electronic element 23 is disposed on the second side of the first circuit structure 21.

As shown in FIG. 5, the second carrier 28 and the adhesive glue 263 are removed to complete the electronic package 2.

The electronic package 2 shown in FIG. 5 includes the first circuit structure 21, the electronic element 23, the heat-conducting layer 233, the plurality of conductive pillars 22, the encapsulation layer 24, the second circuit structure 25, the plurality of conduction elements 26 and the photonic element 27.

The electronic element 23 is coupled to the second side of the first circuit structure 21 via the first conductive blocks 231, and the photonic element 27 is coupled to the first side of the first circuit structure 21 via the second conductive blocks 271. Therefore, the first circuit structure 21 is between the electronic element 23 and the photonic element 27. The circuit layer 212 of the first circuit structure 21 is electrically connected to the electronic element 23 via the first conductive blocks 231 and is electrically connected to the photonic element 27 via the second conductive blocks 271.

The heat-conducting layer 233 is formed between the non-active surface 23b of the electronic element 23 and the first side of the second circuit structure 25. The conductive pillars 22 are disposed between the first circuit structure 21 and the second circuit structure 25 and are electrically connected to the circuit layer 212 of the first circuit structure 21 and the circuit layer 252 of the second circuit structure 25. The encapsulation layer 24 is formed between the first circuit structure 21 and the second circuit structure 25 and covers the electronic element 23, the heat-conducting layer 233 and the conductive pillars 22. The conduction elements 26 are disposed on the second side of the second circuit structure 25.

As shown in FIG. 5, each of the conduction elements 26 may include at least one electrically conductive element 261 and at least one heat-conducting element 262. The electrically conductive elements 261 are electrically connected to the electronic element 23 and/or the photonic element 27 via the circuit layer 252 of the second circuit structure 25, the conductive pillars 22, and the circuit layer 212 of the first circuit structure 21 to transmit electrical signals of the electronic element 23 and/or the photonic element 27. The heat-conducting elements 262 are thermally coupled to the electronic element 23 via the circuit layer 252 of the second circuit structure 25 and the heat-conducting layer 233 to transfer the heat generated from the electronic element 23 during operation, which avoids overheating of the electronic element 23.

In an embodiment, the dimension (e.g., the width or the diameter) D₁ of each of the plurality of heat-conducting elements 262 is greater than the dimension (e.g., the width or the diameter) D₂ of each of the plurality of electrically conductive elements 261.

In an embodiment, at least one of the heat-conducting elements 262 is electrically connected to the electronic element 23 and/or the photonic element 27 via the second circuit structure 25, the conductive pillar 22 and the first circuit structure 21 to serve as the power end or ground end of the electronic element 23 and/or the photonic element 27.

In an embodiment, a heat dissipation region 253 is provided on the second side of the second circuit structure 25, and the heat-conducting elements 262 occupy at least 60% of the area of the heat dissipation region 253, so that heat can be rapidly dissipated without affecting the operation of the electronic element 23.

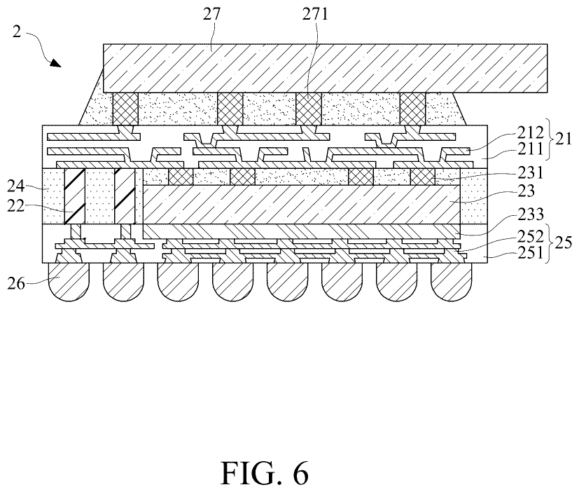

FIG. 6 is a schematic cross-sectional view showing an electronic package 2 according to another embodiment of the present disclosure. The heat-conducting layer 233 in the embodiment is embedded in the second circuit structure 25, and the first side of the heat-conducting layer 233 (i.e., the upper surface shown in FIG. 6) is flush with the first side of the second circuit structure 25 (i.e., the upper surface shown in FIG. 6).

To sum up, in the electronic package 2 and manufacturing method thereof of the present disclosure, the heat-conducting layer 233 is attached to the non-active surface 23b of the electronic element 23, and the second circuit structure 25 is thermally coupled to the electronic element 23 via the heat-conducting layer 233 to improve the heat dissipation efficiency of the electronic element 23 during operation, which may improve the heat dissipation capacity of the electronic package 2 by 5%-10%.

The above embodiments are provided for illustrating the principles of the present disclosure and its technical effect, and should not be construed as to limit the present disclosure in any way. The above embodiments can be modified by one of ordinary skill in the art without departing from the spirit and scope of the present disclosure. Therefore, the scope claimed of the present disclosure should be defined by the following claims.

What is claimed is:

1. An electronic package, comprising:
a first circuit structure having a first side and a second side opposite to the first side;
a photonic element disposed on the first side of the first circuit structure and electrically connected to the first circuit structure;
an electronic element having an active surface and a non-active surface opposite to the active surface, disposed on the second side of the first circuit structure via the active surface, and electrically connected to the first circuit structure;
a heat-conducting layer formed on the non-active surface of the electronic element; and
a second circuit structure disposed on the second side of the first circuit structure, electrically connected to the first circuit structure, and thermally coupled to the electronic element via the heat-conducting layer.

2. The electronic package of claim 1, wherein the heat-conducting layer is embedded in the second circuit structure.

3. The electronic package of claim 1, further comprising:
a plurality of conductive pillars disposed between the first circuit structure and the second circuit structure, wherein the second circuit structure is electrically connected to the first circuit structure via the plurality of conductive pillars.

4. The electronic package of claim 3, further comprising:
an encapsulation layer formed between the first circuit structure and the second circuit structure and covering the electronic element and the plurality of conductive pillars.

5. The electronic package of claim 1, wherein the second circuit structure has a first side and a second side opposite to the first side, the heat-conducting layer is formed on the first side of the second circuit structure, and the electronic package further comprises:
a plurality of electrically conductive elements disposed on the second side of the second circuit structure and electrically connected to the electronic element and/or the photonic element via the second circuit structure and the first circuit structure; and
a plurality of heat-conducting elements disposed on the second side of the second circuit structure and thermally coupled to the electronic element via the second circuit structure and the heat-conducting layer.

6. The electronic package of claim 5, wherein a dimension of each of the plurality of heat-conducting elements is greater than a dimension of each of the plurality of electrically conductive elements.

7. The electronic package of claim 5, wherein the plurality of heat-conducting elements are electrically connected to the electronic element and/or the photonic element via the second circuit structure and the first circuit structure and serve as power ends or ground ends of the electronic element and/or the photonic element.

8. The electronic package of claim 5, wherein the second side of the second circuit structure has a heat dissipation region thereon, the electronic package comprises the plurality of heat-conducting elements, and the plurality of heat-conducting elements occupy at least 60% of an area of the heat dissipation region.

9. A method of manufacturing an electronic package, comprising:
disposing an electronic element on a first circuit structure, wherein the electronic element has an active surface and a non-active surface opposite to the active surface, and the electronic element is electrically connected to the first circuit structure via the active surface;
forming a heat-conducting layer on the non-active surface of the electronic element;
forming a second circuit structure on the heat-conducting layer, and electrically connecting the second circuit structure to the first circuit structure, wherein the second circuit structure is thermally coupled to the electronic element via the heat-conducting layer; and
disposing a photonic element on the first circuit structure, and electrically connecting the photonic element to the electronic element via the first circuit structure.

10. The method of claim 9, wherein the heat-conducting layer is embedded in the second circuit structure.

11. The method of claim 9, further comprising:
before disposing the second circuit structure on the heat-conducting layer, disposing a plurality of conductive pillars on the first circuit structure, wherein the second circuit structure is electrically connected to the first circuit structure via the plurality of conductive pillars.

12. The method of claim 11, further comprising:
before disposing the second circuit structure on the heat-conducting layer, forming an encapsulation layer on the first circuit structure to cover the electronic element and the plurality of conductive pillars.

13. The method of claim 9, wherein the second circuit structure has a first side and a second side opposite to the first side, the heat-conducting layer is formed on the first side of the second circuit structure, and the method of manufacturing the electronic package further comprises:
disposing a plurality of electrically conductive elements on the second side of the second circuit structure, wherein the plurality of electrically conductive elements are electrically connected to the electronic element and/or the photonic element via the second circuit structure and the first circuit structure; and
disposing a plurality of heat-conducting elements on the second side of the second circuit structure, wherein the plurality of heat-conducting elements are thermally coupled to the electronic element via the second circuit structure and the heat-conducting layer.

14. The method of claim 13, wherein a dimension of each of the plurality of heat-conducting elements is greater than a dimension of each of the plurality of electrically conductive elements.

15. The method of claim 13, wherein the plurality of heat-conducting elements are electrically connected to the electronic element and/or the photonic element via the second circuit structure and the first circuit structure and serve as power ends or ground ends of the electronic element and/or the photonic element.

16. The method of claim 13, wherein the plurality of heat-conducting elements are disposed on a heat dissipation region on the second side of the second circuit structure, and the plurality of heat-conducting elements occupy at least 60% of an area of the heat dissipation region.
